(19) United States
(12) Patent Application Publication
(10) Pub. No.: US 2023/0191739 A1
(43) Pub. Date: Jun. 22, 2023

(54) A JIG FOR MANUFACTURING A CONTAINER WITH A ROLLED FREE EDGE

(71) Applicant: MuCell Extrusion, LLC, Woburn, MA (US)

(72) Inventor: Torben Andersen, Stilling, Skanderborg (DK)

(73) Assignee: MuCell Extrusion, LLC, Woburn, MA (US)

(21) Appl. No.: 17/925,338

(22) PCT Filed: May 14, 2021
(86) PCT No.: PCT/EP2021/062840

§ 371 Date: Nov. 15, 2022

(30) Foreign Application Priority Data
May 15, 2020 (DK) PA202070320

(51) Int. Cl. B31F 1/00

(52) U.S. Cl. CPC B31F 1/0038; B31F 1/0087; B31B 2120/002

(57) ABSTRACT

The present disclosure envisages a jig (100) for manufacturing a container with a rolled free edge. The jig (100) comprises a container fixture (110) and a rolling die (150). The container fixture (110) comprises a first set of split jaws (125) abutting an operative outer side of the container near the free edge of the container, and arranged to slide along the outer sides of the container, thereby supporting the outer sides during the rolling operation. The rolling die (150) of one embodiment comprises a second set of split jaws (165) having a rounded groove (155), the split jaws of said second set of split jaws are arranged to contract during the rolling operation.

### FIELD OF THE INVENTION

The present disclosure relates to the field of jigs for rolling edges of containers.

### BACKGROUND OF THE INVENTION

In standard paper containers, for example paper drinking cups, the free edge of the container is rolled in a rolling operation to strengthen the free edge and also give a smooth edge.

Typically, a jig is used to curl the upper edge of a container. A conventional jig comprises a first die and a second die. The container is held by the first die, whereas the second die is pressed onto the edge of the container which needs to be curled. The second die has a rounded groove facing the edge of the container. Typically, the groove is a downward facing groove, and the second die with the groove is displaced in a downward direction towards the free edge of the container which is held in the first die underneath the second die. The edge of the container starts to curl as the second die is displaced further downwards. One of the conventional jigs is shown in US20080029525. Another example of a conventional jig is shown in US3065677. As disclosed in US20080029525 and US3065677, the reciprocating striking tool (second die) is provided with an annular groove that facilitates curling of an edge of a cup. The striking tool is displaced vertically downwards to facilitate the curling of the edge in the annular groove. However, the rolling operation has been found to be susceptible to failure. When the operation fails, the container in the jig will be deformed and will need to be thrown out.

Therefore, there is felt a need for a jig that alleviates the aforementioned drawbacks of conventional jigs, and facilitates a rolling operation on the free edge of a container.

### OBJECTS

An object of the present disclosure is to provide a jig that helps in performing a rolling operation on the free edge of a container.

Another object of the present disclosure is to provide a jig that supports the outer sides of a container during a rolling operation.

Yet another object of the present disclosure is to provide a jig that accommodates tapered containers in a better way than prior art jigs.

Yet another object of the present invention is to provide a jig that will allow a greater amount of material to be rolled at the upper edge than in prior art jigs.

### SUMMARY OF THE INVENTION

The present disclosure discloses a jig for manufacturing a container with a rolled free edge. The jig comprises a first die being arranged as a container fixture and a second die being arranged as a rolling die. The container fixture comprises an open recess configured to receive a container therein. The rolling die comprises a rounded groove facing the container fixture for curling the free edge of the container. The container fixture comprises a first set of split jaws abutting an operative outer side of a container when a container is arranged in the container fixture, said jaws of said first set of split jaws being arranged to slide along a first sliding mechanism such that they slide along the operative outer side of said container during the rolling operation, said first sliding mechanism being arranged such that the jaws of the first set of split jaws displace along a path having an angle to a longitudinal centre axis of the open recess of the container fixture corresponding to an angle of the operative outer side of the container to the longitudinal centre axis of the open recess of the container fixture.

In one embodiment, the rolling die comprises a second set of split jaws, said rounded groove being arranged in the split jaws of the second set of split jaws, said second set of split jaws being arranged to contract during the rolling operation, such that an outer periphery of the rounded groove is reduced during the rolling operation. In one embodiment, the rounded groove lies on a closed loop arranged on a plane which is perpendicular to the longitudinal axis of the container recess.

In one embodiment, the rounded groove has a diameter D in a plane perpendicular to the longitudinal centre axis of the container recess, said second set of split jaws being arranged to contract during the rolling operation, such that the diameter D is reduced during the rolling operation.

In one embodiment, each of the first set of split jaws and the second set of split jaws is provided with contacting surfaces that abut each other when the first and second set of jaws contact each other. When either of the rolling die or the container fixture is moved towards the other, the first set of split jaws and the second set of split jaws contact each other, and the relative motion between the rolling die and container fixture displaces the first set of split jaws which is displaced inwardly due to the angle of the first sliding mechanism, thereby causing the second set of split jaws to also displace inwardly.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

A jig, of the present disclosure, is now described with reference to the accompanying drawings, in which:

FIG. 1 illustrates an isometric view of the jig of the present disclosure;

FIG. 2 illustrates an isometric view of a rolling die of the jig of the present disclosure;

FIG. 3 schematically illustrates a partial sectional side view of the jig of FIG. 1 before initiating a rolling operation on a container; and

FIG. 4 schematically illustrates a partial sectional side view of the jig of FIG. 1 during the rolling operation.

FIG. 5 schematically illustrates a partial sectional side view of the jig of FIG. 1 at the end of the rolling operation.

In the following, the invention will be described in greater detail with reference to embodiments shown by the enclosed figures. It should be emphasized that the embodiments shown are used for example purposes only and should not be used to limit the scope of the invention.

### DETAILED DESCRIPTION

The present disclosure discloses a jig for manufacturing a container with a rolled free edge. Rolling the free edge provides stiffness to the free edge of the container and provides a container with a smooth free edge. More specifically, the jig according to the current invention helps in performing a rolling operation on a free edge of a container. In the rolling operation, the free edge of the container is rolled outwards and downwards (in the typical use situation of the container) towards the outer sides of the container.

The jig 100 comprises a container fixture 110 and a rolling die 150.

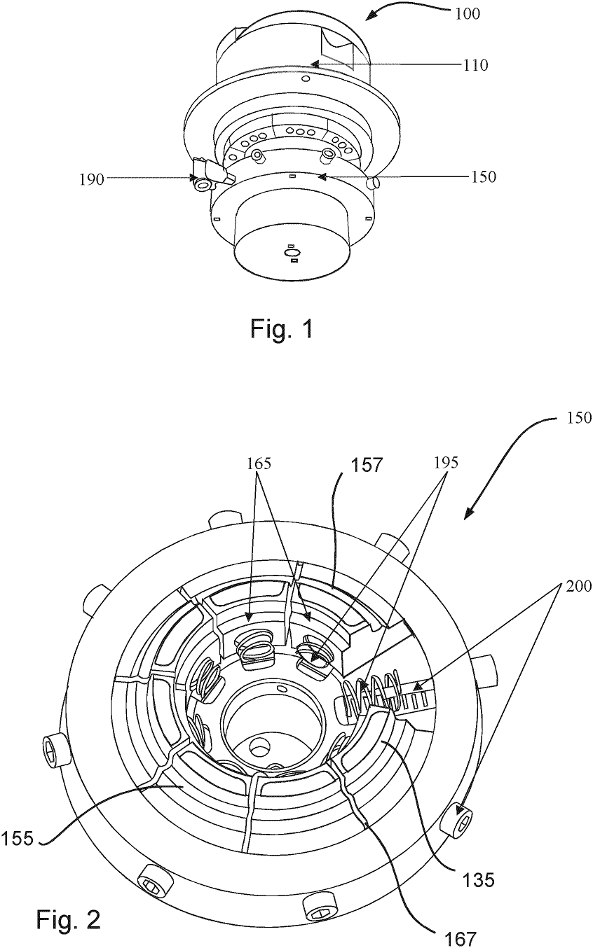

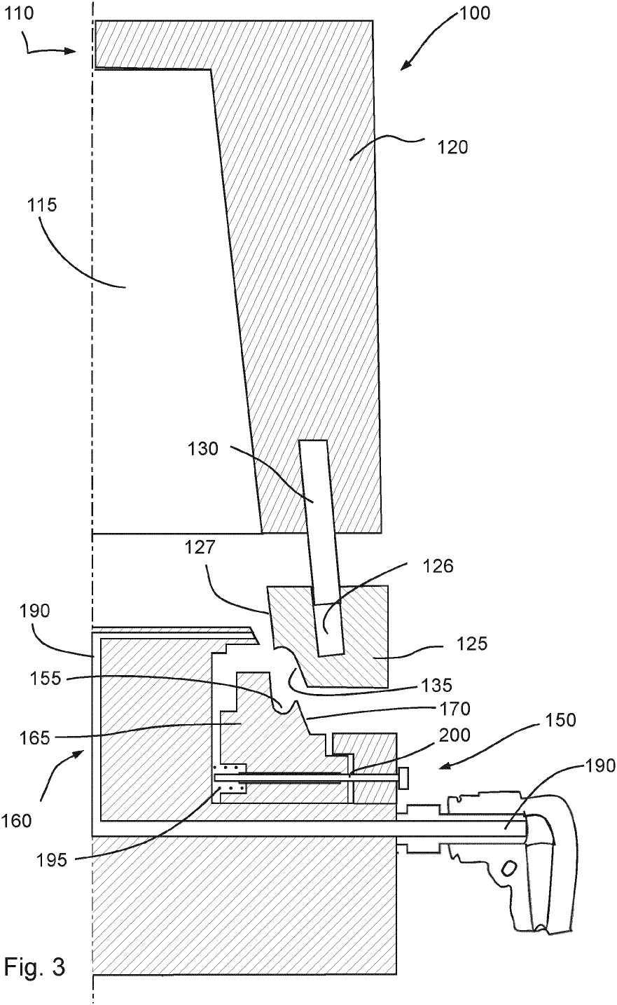

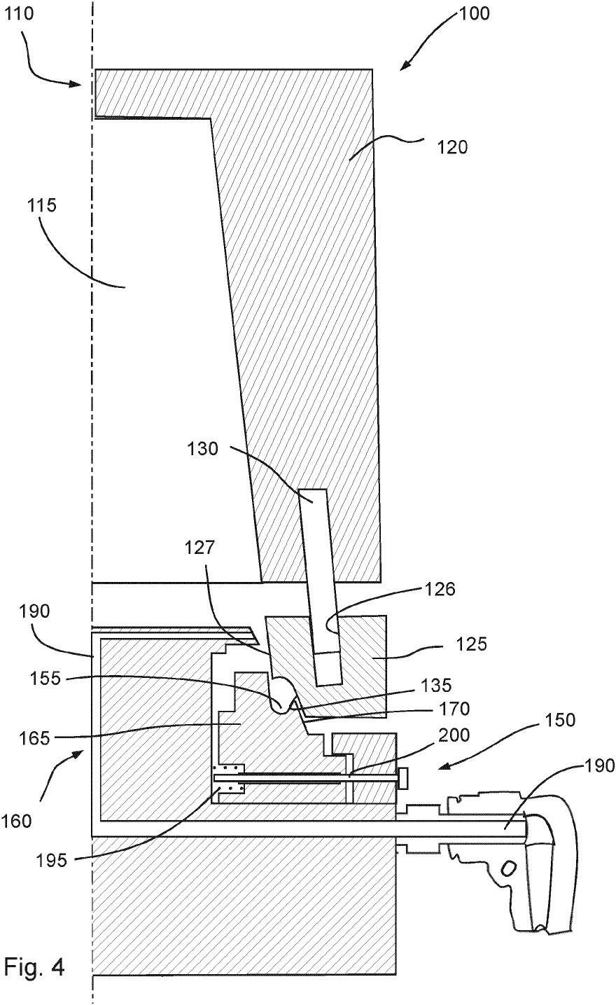

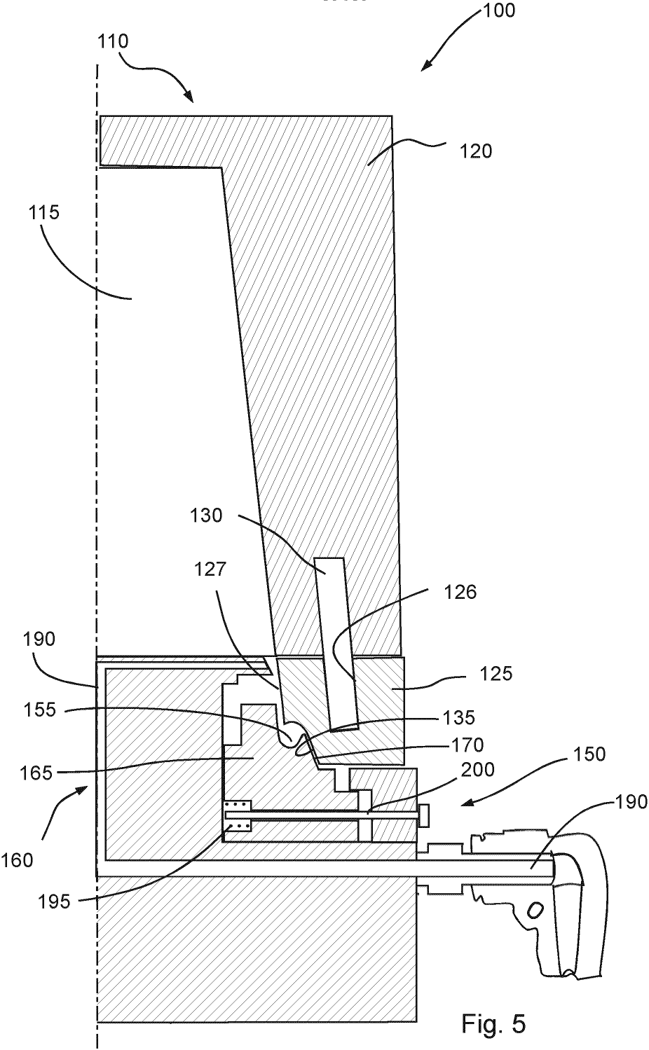

A first embodiment of a jig 100 of the present invention is illustrated in FIGS. 1 to 4. FIG. 1 illustrates an isometric view of the jig 100. FIG. 2 illustrates a perspective view of the rolling die. FIG. 3 illustrates a sectional view of the jig 100 before initiating a rolling operation on a container. FIG. 4 illustrates a sectional view of the jig 100 while performing the rolling operation and FIG. 5 illustrates a sectional view of the jig 100 at the end of the rolling operation.

The container fixture 110 has an open recess 115 configured to receive a container (not shown) therein whose free edge is to be curled/rolled. The recess 115 has a shape complementary to the outer surface of the container to be received. The container is received in the recess 115 such that the open end of the container having the free edge to be rolled faces the rolling die 150.

In an embodiment, the container can be a cup of paperboard, plastic, or metal.

It should be noted that in the current embodiment, the container is arranged in the container recess 115 such that the free edge of the container is facing downwardly and the “bottom” of the container is facing upwardly. In FIGS. 3-5, only half of the jig is show so that only half of the container recess 115 is shown.

The container fixture 110 comprises a hollow fixture body 120 in which the recess 115 is formed. The container fixture 110 comprises a first set of split jaws 125 arranged in the fixture body 120. A support surface 127 of the jaws of the first set of split jaws 125 abuts an operative outer side of the container when the container is placed in the recess. The jaws are arranged to slide along the outer side(s) of the container during the rolling operation. Thus, the outer side of the container near the free edge is well supported during the rolling operation. This prevents buckling/collapsing of the container during the rolling operation as is sometimes observed in conventional jigs. In conventional jigs, there is often an upper exposed portion of container side wall which has no support.

By arranging support for the upper portion of the outer surface of the container during the rolling operation, the curl operation can be performed over a larger distance with less risk of the side surface collapsing since the material of the upper edge is stressed less. By performing the curl operation over a larger distance, more material can be placed in the curled portion, allowing a stiffer and more stable rim portion.

The jig 100 comprises a first sliding mechanism 125, 130 that facilitates sliding of the first set of split jaws 125 along the outer sides of the container. More specifically, the jaws of the first set of split jaws 125 are arranged to slide along the first sliding mechanism. The first sliding mechanism guides each of the jaws of the first set of split jaws 125 along the outer sides of the container. The first sliding mechanism is arranged within the fixture body 120 of the container fixture 110 at an angle corresponding to the angle of the outer sides of the container to the longitudinal centre axis of the open recess. More specifically, an angle made by the first sliding mechanism with a vertical or horizontal axis of the jig 100 is equal to the angle made by the outer sides of the container with the vertical or horizontal axis of the jig 100 respectively when the container is received in the recess 115.

In an embodiment, the first sliding mechanism includes a plurality of pins 130. The pins 130 are arranged fixed within the fixture body 120 of the container fixture 110, in a spaced apart configuration from the outer sides of the container and evenly arrayed around the circumference of the container recess. The pins 130 are arranged such that the pins 130 are parallel to the outer sides of the container. In an embodiment, the supporting surface 127 of the jaws of the first set of split jaws 125 is arranged between the outer sides of the container and the pins 130. Each jaw of the first set of split jaws 125 is provided with a slot 126 to receive a pin 130 therein. The slot is so configured that the jaw 125 can slide along the pin 130. In an embodiment, the pin 130 is a rigid bar. In one embodiment, the pin 130 has a circular cross section.

Further, the supporting surface 127 of the jaws has a tapered angle corresponding to the angle of the outer sides of the container.

In the current embodiment, the jaws are mounted on pins and slide along the pins. However, within the scope of the invention, other sliding arrangements could be used. The person skilled in the art of machinery design will be able to provide suitable designs.

The rolling die 150 comprises a rounded groove 155. The rounded groove 155 faces the container fixture 110, and is configured to facilitate curling of the free edge of the container. The rounded groove, when seen on a plane which is perpendicular to the longitudinal axis of the container recess, matches the outer periphery of the opening of the container. In this embodiment, the container has a circular opening and as such, the rounded groove also has a circular shape with a diameter D.

The rolling die 150 comprises a hollow die body 160. Further, the rolling die 150 comprises a second set of split jaws 165 arranged in the die body 160. The second set of split jaws 165 comprises the rounded groove 155. More specifically, a portion 157 of the groove 155 is configured on each of the second set of split jaws 165 which together form the complete rounded groove 155.

The second set of split jaws 165 is arranged to contract during the rolling operation such that the diameter D is reduced. More specifically, the gap 167 between adjacent jaws of the second set of split jaws 165 keeps on reducing as the rolling operation progresses and the second set of split jaws 165 is displaced further in the direction of the container fixture 110.

In an embodiment, the rolling die 150 comprises a second sliding mechanism 200 configured to horizontally displace the second set of split jaws 165, thereby facilitating contraction of the second set of split jaws 165. The second sliding mechanism comprises a plurality of springs 195 and horizontal pins 200. More specifically, each jaw of the second set of split jaws 165 is slidably mounted on a horizontal pin 200, and is provided with a spring 195. The springs 195 are arranged such that when the second set of split jaws 165 is moved inwardly, the springs 195 get compressed. When the second set of split jaws is released, they move outwardly due to the force exerted by the springs.

Each jaw of the first set of split jaws 125 and the second set of split jaws 165 has a contacting surface 135, 170. In an embodiment, the contacting surfaces 135, 170 of the first set of split jaws 125 and the second set of split jaws 165 are tapered surfaces. The tapered contacting surfaces 135, 170 have complementary tapered angles. The tapered contacting surfaces 135, 170 facilitates motion of the second set of split jaws 165 when the first set of split jaws 125 and the second set of split jaws 165 contact each other.

When the rolling die 150 is pushed towards the container fixture 110, the tapered surface 170 of each of the jaws of the second set of split jaws 165 contacts the tapered surface 135 of the corresponding jaws of the first set of jaws 125. These two tapered surfaces are then joined together. As the rolling die 150 is pushed further upwards towards the container fixture 110, the second set of split jaws 165 is pushed upwardly with respect to the container fixture. This causes the first set of split jaws 125 to also displace upwardly with respect to the container fixture. Since the jaws of the first set of split jaws 125 are sliding on angled pins 130, as the jaws of the first set of split jaws 125 move upwardly, they simultaneously move inwardly. Due to the connection between the first and second set of jaws, the jaws of the second set of jaws are also displaced inwardly.

Thus, the two sets of jaws lock together and then move together. They move inwards in the same amount, and as they have the same radius at the contact surface, they also remain joined together.

When the rolling die 150 is displaced away from the container fixture 110, the first set of jaws 125 moves downwards due to gravity, and pushes the second set of jaws 165 outwardly. The compressed springs 195 also bias the second set of split jaws 165 into their original/initial position. When the rolling die is displaced far enough away from the container fixture, the jaws of the first and second set of jaws release each other. Since the contacting surface is tapered, the two surfaces easily release each other.

In an open position, i.e., before initiating the rolling operation, the second set of split jaws 165 are out. During the rolling operation, the second set of split jaws 165 move inwardly to adjust the diameter of the rounded rolling groove with the taper of the container. In this way, the rounded groove 155 adjusts its diameter to fit the taper on the outer sides of the container.

In an inoperative configuration, each of the jaws of the first set of split jaws 125 and the jaws of the second set of split jaws 165 do not abut adjacent jaws in the same set and a gap 126, 167 is provided between adjacent jaws. In an operative configuration or as the rolling operation progresses, the gap 126, 167 between adjacent jaws of respective sets of jaws starts reducing, and thereafter, the jaws may abut adjacent jaws in the same set of jaws.

The number of jaws in each of the first set of split jaws 125 and the second set of split jaws 165 can vary as per the application requirement and the size and shape of the container. In an embodiment, each of the first set of split jaws 125 and the second set of split jaws 165 comprises equal number of jaws arranged circumferentially. In an embodiment, each of the first set of split jaws 125 and the second set of split jaws 165 comprises eight jaws.

The jig 100 comprises an actuator configured to displace either the container fixture 110 or the rolling die 150 towards the other, wherein the other remains fixed. In an embodiment, the actuator is coupled to the container fixture 110, and displaces the same towards the rolling die 150. In another embodiment, the actuator is coupled to the rolling die 150, and displaces the same towards the container fixture 110.

It is to be noted that, although the container fixture 110 is shown in accompanying figures as an upper part, the entire structure of the jig 100 can be inverted with the container fixture 110 being a lower part and the rolling die 150 being an upper part.

The jig 100 further comprises a channel 190 configured within the die body 160 of the rolling die 150. The channel 190 is configured to facilitate flow of a lubricant, typically silicon, dripping onto the rounded groove 155. The lubricant is passed through the channel 190. Silicon drips out slowly from the end of the channel 190 to fall on to the rounded groove 155. The lubricant reduces friction between the container and the jig 100 during the rolling operation. As the lubricant is applied via a slow drip process, there is no formation of a lubricant cloud (which is formed in the prior art type lubrication systems) in the vicinity around the jig 100, and the lubricant is concentrated only around the rounded groove 155 and nowhere else. This prevents wastage of the lubricant. The aforementioned disclosure of the lubrication arrangement could be the subject of a potential divisional application to be filed in the future. For example, a jig comprising a rolling die and a container fixture, said rolling die comprising a rounded groove suitable for rolling the free edge of a container placed in the container fixture, said rolling die being arranged below the container fixture, said jig comprising a lubricating arrangement whereby a lubrication outlet is provided above the rounded groove, such that lubricant forced out of the lubrication outlet drips down and into the rounded groove.

To perform a rolling operation, the container is placed in the open recess 115 such that the free edge of the container faces the rolling die 150. Further, one of the container fixture 110 and the rolling die 150 is displaced towards the other to establish contact between them. When contacted, the first set of split jaws 125 moves away from the free edge of the container towards the base of the container along the first sliding mechanism due to the push from the second set of split jaws 165. Further, the first set of split jaws 125 starts moving inwardly due to the angular arrangement of the pins 130. The inward movement of the first set of split jaws 125 allows the first set of split jaws 125 to slide along the tapered outer sides of the container, thereby supporting the outer sides during the rolling operation.

When contacted with the free edge of the container, the second set of split jaws 165 start rolling the free edge of the container via the rounded groove 155.

Due to the contacting surfaces 135, 170, the inward motion of the first set of split jaws 125 causes the second set of split jaws 165 to also move inwardly. Thus, motion of the jig 100 can be controlled using a single actuator.

Further, the container fixture 110 or the rolling die 150 can be heated via a form of heating element so that the jig 100 is warmed. This helps in preparing the material for the rolling operation.

It is to be noted that the figures and the above description have shown the example embodiments in a simple and schematic manner. Many of the specific mechanical details have not been shown since the person skilled in the art should be familiar with these details and they would just unnecessarily complicate this description. For example, the specific materials used and the specific manufacturing procedures have not been described in detail since it is maintained that the person skilled in the art would be able to find suitable materials and suitable processes to manufacture the container and jig according to the current invention.

It should also be noted that the current independent claim 1 is focused on a jig where the first set of split jaws is arranged to slide along the outer surface of the container during the rolling operation. In a potential divisional application, an independent claim 1 could be formulated to focus on the second set of split jaws which contract during the rolling operation to reduce the outer periphery of the rounded groove. An independent claim could be formulated as: “A jig for manufacturing a container with a rolled free edge, said jig comprising:
a container fixture comprising an open recess configured to receive a container therein;
a rolling die comprising a rounded groove facing said container fixture, said rounded groove being arranged to correspond to a free edge of a container inserted into the container fixture for curling the free edge of the container, said rolling die being displaceably arranged with respect to the container fixture;
characterized in that said rolling die comprises a set of split jaws comprising the rounded groove, said second set of split jaws being arranged to contract during the rolling operation such that an outer periphery of the rounded groove decreases during the rolling operation.

LIST OF REFERENCE NUMERALS

| | |
|---|---|
| 100 | Jig |
| 110 | Container fixture |
| 115 | Recess |
| 120 | Fixture body |
| 125 | First set of split jaws |
| 127 | Inner surface of the first set of split jaws |
| 130 | Pins |
| 135 | Contacting surface of the container fixture |
| 150 | Rolling die |
| 155 | Groove |
| 160 | Die body |
| 165 | Second set of split jaws |
| 170 | Contacting surface of the rolling die |
| 190 | Channel |
| 195 | Spring |
| 200 | Horizontal pins |

1. A jig for manufacturing a container with a rolled free edge, said jig comprising:
a container fixture comprising an open recess configured to receive a container therein;
a rolling die comprising a rounded groove facing said container fixture, said rounded groove being arranged to correspond to a free edge of a container inserted into the container fixture for curling the free edge of the container, said rolling die being displaceably arranged with respect to the container fixture;
characterized in that,
the container fixture comprises a first set of split jaws abutting an operative outer side of a container when a container is arranged in the container fixture, said jaws of said first set of split jaws being arranged to slide along a first sliding mechanism such that they slide along the operative outer side of said container during the rolling operation, said first sliding mechanism being arranged such that the jaws of the first set of split jaws displace along a path having an angle to a longitudinal centre axis of the open recess of the container fixture corresponding to an angle of the operative outer side of the container to the longitudinal centre axis of the open recess of the container fixture.

2. The jig according to claim 1, characterized in that said first sliding mechanism includes a plurality of pins arranged spaced apart from the operative outer side of the container, arranged around the longitudinal centre axis of the open recess of the container fixture and arranged at an angle to the longitudinal centre axis of the open recess of the container fixture.

3. The jig according to any one of claims 1 to 2, characterized in that the rolling die comprises a second set of split jaws comprising the rounded groove, said second set of split jaws being arranged to contract during the rolling operation such that an outer periphery of the rounded groove decreases during the rolling operation.

4. The jig according to claim 3, characterized in that said rolling die comprises a second sliding mechanism configured to horizontally displace/contract the second set of split jaws.

5. The jig according to claim 4, characterized in that the first set of split jaws and the second set of split jaws have contacting surfaces, whereby when either of the rolling die or the container fixture is moved towards the other, the first set of split jaws and the second set of split jaws contact each other, and the relative motion between the rolling die and container fixture displaces the first set of split jaws longitudinally and inwardly due to the angle of the first sliding mechanism, thereby also causing the second set of split jaws to displace inwardly.

6. The jig according to claim 5, characterized in that the contacting surfaces of the first and second sets of split jaws are tapered surfaces having complementary tapered angles.

7. The jig according to claim 3, characterized in that each of the first and second set of split jaws comprise an equal number of jaws arranged circumferentially.

8. The jig according to claim 1, characterized in that said jig comprises an actuator configured to displace either the rolling die or the container fixture towards the other.

9. The jig according to claim 1, characterized in that each of the first set of split jaws has an operative inner tapered surface having a tapered angle corresponding to the angle of the operative outer side of the container to the longitudinal centre axis of the open recess of the container fixture.

10. The jig according to claim 1, characterized in that said jig is arranged such that the rolling die is arranged below the container fixture, and such that the jig comprises a channel configured to facilitate flow of a lubricant dripping onto said rounded groove.
